(19) United States
(12) Patent Application Publication
(10) Pub. No.: US 2010/0070670 A1
(43) Pub. Date: Mar. 18, 2010

(54) Computer One-Way Data Link

(75) Inventor: David C. Abell, Madison, AL (US)

Correspondence Address: DEPARTMENT OF THE ARMY;LEGAL OFFICE, AMSAM - L - G - I, U.S. ARMY AVIATION & MISSILE COMMAND, REDSTONE ARSENAL, AL, 35898-5000, US

(73) Assignee: United States of America as Represented by the Secretary of the Army, Washington, DC (US)

(21) Appl. No.: 12/210,679

(22) Filed: Sep. 15, 2008

(51) Int. Cl. G06F 13/00

(52) U.S. Cl. 710/302

(57) ABSTRACT

Two computers are serially connected by a one-way cable connection allowing data to be transmitted from the first computer to the second computer, but making it physically impossible to transmit data from the second computer to the first computer. A serial port of the first computer has a transmitting pin in hard-wired communication with a receiving pin of a serial port of the second computer. The grounding pins of the respective serial ports of the first and second computers are hard-wired connected. The invention uses a two-conductor BNC coaxial connection cable and connecting adapters.

The invention described herein may be manufactured, used and licensed by or for the U.S. Government for governmental purposes without payment of any royalties thereon.

### BACKGROUND OF THE INVENTION

I. Field of the Invention

The present invention pertains to data transmission from one computer to another. More particularly the present invention pertains to a one-way link which allows data to be transferred from a first computer to a second computer, but prevents data from being sent from the second computer to the first computer.

II. Discussion of the Background

To prevent computer-stored data from being acquired by an undesirable source, firewalls and other security software are typically employed. However, even sophisticated firewalls have been breached by ingenious hackers. Thus, any two-way electrical connection between computers is a potential conduit for a determined hacker.

### SUMMARY OF THE INVENTION

The present invention provides a one-way connection between a first computer (sending computer) which sends data to a second computer (receiving computer). The one-way connection is the sole transmission path between the two computers. This one-way data link allows the first computer to send information to the second computer, but does not allow the second computer to send information to the first computer.

The one way data link of the present invention makes sending data from the second computer to the first computer a physical impossibility. The link protects information in the receiving computer from being obtained through any unauthorized electrical means. The one-way data link makes possible a one-way computer communication system between two computers.

The one-way computer communication system includes a first computer having a serial port having a transmitting pin and a ground pin and a second computer having a serial port having a receiving pin and a ground pin. The transmitting pin of the first computer is hard-wired to the receiving pin of the second computer to form a first electrical connection, and the ground pin of the first computer and the ground pin of the second computer are hard-wired to form a second electrical connection.

Further, the serial port of said first computer has a Carrier Detect pin, a Data Terminal Ready pin; a Data Set Ready pin; a Request to Send pin; and a Clear to Send pin; and the serial port of the second computer has a Carrier Detect pin, a Data Terminal Ready pin; a Data Set Ready pin; a Request to Send pin; and a Clear to Send pin; and the respective Carrier Detect pins, the respective Data Terminal Ready pins; the respective Data Set Ready pins; the respective Request to Send pins; and the respective Clear to Send pins of the first computer and the second computer are shorted; and the first electrical connection and said second electrical connection are the only electrical connections between the first computer and said second computer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of the data link according to the present invention which connects a first computer to a second computer.

FIG. 2 is schematic illustration of the wiring of the conductor element and grounding element of the one-way data link of the present invention.

FIG. 3 is a sideview, partial x-ray view of the one-way data link of the present invention.

FIG. 4 is plan view of the one-way data link of the present invention.

FIG. 5 is flow chart of the process by which data is sent from a first computer along the one-way data link for secure processing by a second computer.

### DETAILED DESCRIPTION

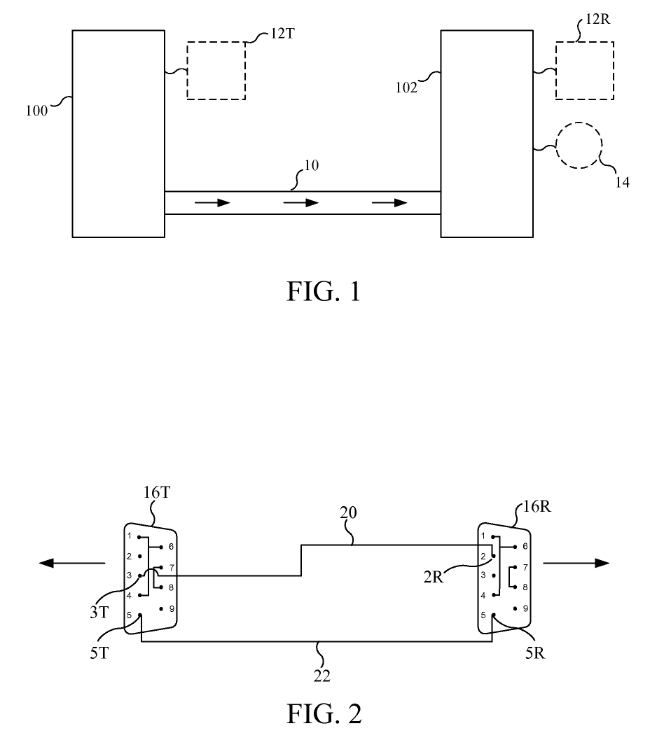

With reference to FIG. 1, a first computer 100 is connected to a second computer 102 by a one-way data link or cable 10 of the present invention. First computer 100 contains data 12T which is to be transmitted along the one-way data link 10 to second computer 102. The data 12T is stored in memory of computer 102 as received data 12R. The received data 12R can be utilized with other data in computer 102 and can be processed by means of software which can include mathematical processing and statistical software 14 which has been loaded onto second computer 102.

FIG. 2 demonstrates how the one-way data link 10 is wired to the serial port 16T (e.g., COM1 port) of the first computer 100 and to the serial port 16R (e.g., COM1 port) of second computer 102. The wiring may be viewed as a RS-232 Null Modem connection with the exception being that the transmit pin 3T (e.g., pin 3 of the DB-9 connection) of serial port 16T is connected to the receive pin 2R (e.g., pin 2 of the DB-9 connection) of serial port 16R; however, no transmit pin of the second computer is connected with a receive pin of the first computer.

Accordingly, the connection 20 between transmit pin 3T and receive pin 2R is the sole data transmission path between first computer 100 and second computer 102 and that sole data transmission path is a one-way path. Information can be sent from the first computer 100 to the second computer 102, but no information can be sent from second computer 102 to first computer 100.

Still with reference to FIG. 2, a grounding connection 22 connects ground pin 5T (e.g., pin 5 of the DB-9 connection of serial port 16T) with the ground pin 5R (e.g., pin 5 of the DB-9 connection of serial port 16R).

In the serial port 16T of first computer 100 and in serial port 16R of second computer 102, pins 1, 4, 6, 7 and 8 are shorted. (In RS-232, DB-9 connections, pin 1 pertains to the Carrier Detect function; pin 2 pertains to the Receive Data function; Pin 3 pertains to the Transmit Data function; Pin 4 pertains to a Data Terminal Ready function; pin 5 refers to a Chassis Ground function; pin 6 pertains to a Data Set Ready function; pin 7 refers to a Request to Send function; pin 8 refers to a Clear to Send function; and pin 9 pertains to a Ring Indicator function.)

Thus, when using the one-way data link of the present invention, no handshaking is involved between computers and no sending-receiving software is necessary.

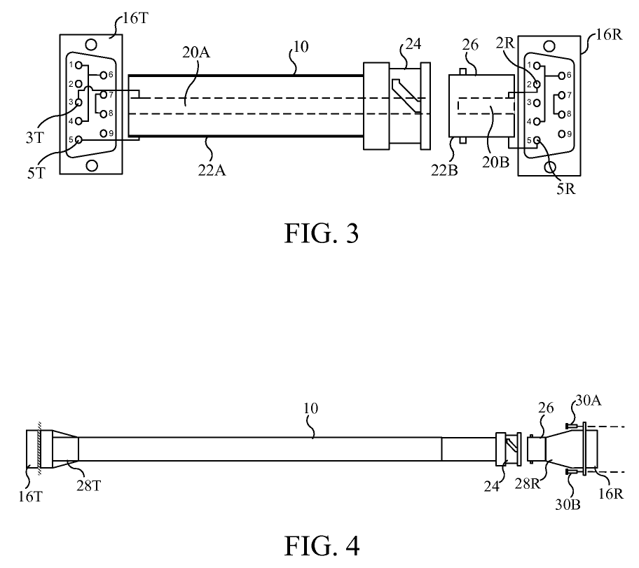

In FIG. 3, the one-way data link cable 10 is seen to be a coaxial cable having a center conductor 20A which is wired to the transmit pin 3T of serial port 16T of first computer 100. The ground pin 5R of serial port 16T is wired to outer conductor 22A (grounding connection) of cable 10.

At the other end of the one-way data link cable 10, a connector 24 (e.g., a BNC male connector) connects to an adapter 26 (e.g., a BNC female to DB-9 female adapter) such that center conductors 20A and 20B are connected to connect pin 3T of serial port 16T and to pin 2R of serial port 16R. Further, the connection of connector 24 with adapter 26 connects outer conductors 22A and 22B to make a grounding connection between ground pin 5T (of serial port 16T of the first computer 100) and ground pin 5R (of serial port 16R of the second computer 102).

In FIG. 4, screws 30A, 30B are used to secure the connector 28R to the serial port 16R of the second computer. Connector 28R which makes pin connections to receive data pin 2R and ground pin 5R of serial port 16R is attached to adapter 26.

Adapter 26 connects to BNC connector 24 of one-way link or cable 10 which is connected to connector 28T which makes a pin connection with transmitting pin 3T and ground pin 5T of serial port 16T.

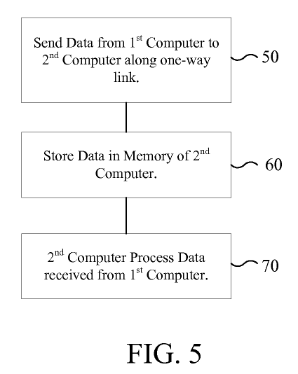

With reference to FIG. 5, the function of sending data 50 from the first computer 100 to the second computer 102 along the one-way data link results in the second computer 102 storing the received data 60 in the memory of the second computer with the second computer processing the received data 70 in conjunction with preselected software programs loaded onto the second computer.

Accordingly, for example, information contained in the first computer, which could be information received over the internet or by other means, can be securely transferred to the second computer where the information can be processed by software which is not intended for access by the general public. To further protect the contents of the second computer, the second computer 102 might be in a location, for example, which is only accessible to a selected group of individuals.

In tests of the present invention, data has been transferred from the sending computer to a receiving computer using at a transfer rate of 115,200 baud with no errors.

The present invention allows for a simple and effective means to transfer data into a computer while making it physically impossible to transfer data electronically to another computer.

It is recognized that adaptations consistent with the spirit of the present invention may be forthcoming; thus, the scope the present invention is limited by the claims which follow, only.

What is claimed is:

1. A one-way computer communication system between two computers, comprising:
a first computer having a serial port having a transmitting pin and a ground pin;
a second computer having a serial port having a receiving pin and a ground pin; and
wherein said transmitting pin of the first computer is hard-wired to said receiving pin of said second computer to form a first electrical connection, and said ground pin of said first computer and said ground pin of said second computer are hard-wired to form a second electrical connection; and
wherein said serial port of said first computer has a Carrier Detect pin, a Data Terminal Ready pin; a Data Set Ready pin; a Request to Send pin; and a Clear to Send pin; and
wherein said serial port of said second computer has a Carrier Detect pin, a Data Terminal Ready pin; a Data Set Ready pin; a Request to Send pin; and a Clear to Send pin; and
wherein said respective Carrier Detect pins, said respective Data Terminal Ready pins; said respective Data Set Ready pins; said respective Request to Send pins; and said respective Clear to Send pins of said first computer and said second computer are shorted; and
wherein said first electrical connection and said second electrical connection are the only electrical connections between the first computer and said second computer.

2. A one-way computer communication system according to claim 1, wherein said first electrical connection comprises:
a coaxial cable having a center conductor which connects to a conductor element of an adapter, said conductor element of said adapter being for the purpose of making an electrical connection with said receiving pin of said serial port of said second computer.

3. A one-way computer communication system according to claim 2, wherein said second electrical connection comprises:
an outer conductor of said coaxial cable which connects to an outer conductor element of said adapter.

4. A one-way computer communication system according to claim 3, wherein:
said coaxial cable includes a BNC connector which is fitted into said adapter.

5. A one-way computer communication system according to claim 4, wherein:
transferring data from the second computer to the first computer through said coaxial cable is physically impossible.
